(19) United States
(12) Patent Application Publication
(10) Pub. No.: US 2009/0199344 A1
(43) Pub. Date: Aug. 13, 2009

(54) FISHING TOOL FOR CRIMPING FERRULES

(75) Inventors: Jeremy Grayson, Kowloon (HK); Philippe Guigo, Belfort (FR); Andrew Jones, Westville (ZA)

Correspondence Address: DORITY & MANNING, P.A., POST OFFICE BOX 1449, GREENVILLE, SC, 29602-1449, US

(73) Assignee: Normark Innovations, Inc.

(21) Appl. No.: 11/876,038

(22) Filed: Oct. 22, 2007

(51) Int. Cl. A01K 97/00

(52) U.S. Cl. 7/106; 81/424.5; 81/426.5

(57) ABSTRACT

An improved fishing tool for crimping ferrules to fasten segments of fishing line together is disclosed. The improved fishing tool has a pair of jaws defining a plurality of grooves with varying transversely-oriented lengths and varying thickness. The varying transversely-oriented lengths and thickness of the plurality of grooves allows the fishing tool to perform a crimping operation on ferrules of varying sizes along the middle portion of the ferrules without crimping the ends of the ferrules.

### TECHNICAL FIELD OF THE INVENTION

The present invention relates to an improved fishing tool for crimping ferrules to fasten segments of fishing lines together. More particularly, the fishing tool is configured so that it can perform a crimping operation on ferrules of varying sizes along the middle portion of the ferrules in order to avoid crimping the ferrules along the edges. The fishing tool is also configured so that segments of fishing line can be fastened together by perform a crimping operation only once on a ferrule rather than multiple times.

### BACKGROUND OF THE INVENTION

Sport fishing is enjoyed around the world. From fresh water to salt water, a wide variety of fish species exist. Fishermen employ a variety of equipment and tackle depending upon the water being fished, the time of day, the species of fish sought, personal choice, and many other factors. Fishing lines form an essential part of such equipment and tackle.

Fishing lines are available in a variety of types, sizes and test strengths. The test strength of a fishing line refers to the maximum stress a fishing line can withstand before breaking. The size of the fishing line refers to the diameter of the fishing line. The diameter of the fishing line helps determine the fishing line's test strength. Fishing line is available in a variety of types of materials including monofilament, braided, or fluorocarbon.

Many types and sizes of fishing line are employed in deep sea fishing. A typical deep sea fishing line arrangement involves a main fishing line and a leader line. The bait and hook are attached to the leader line. The main fishing line is attached to a reel and typically terminates at a snap swivel. A snap swivel is essentially a swivel that has a snap attached to one end. Fishermen use the snap to attach and unattach leader lines to the main fishing line. The swivel prevents the main fishing line from undesirably twisting in the reel when the bait attached to the leader lines swirls in the water or when a hooked fish spins.

The main fishing line is typically of lighter test strength and smaller diameter than the leader line. Because of the small size of the main fishing line, it is easy to tie knots in the main fishing line in order to secure the fishing line to the reel or to the snap swivel. In contrast, the leader line is usually of much greater size and test strength than the main fishing line. It is often very difficult to tie knots in the leader line in order to connect the leader line to the snap swivel or to a hook. To solve this problem, the leader line is usually made to form a loop. Once a loop has been formed in the leader line, the loop is “snapped” into the snap swivel to connect the leader line to the main fishing line. In order to form a loop in a leader line or other fishing line, it is necessary for fishermen to fasten multiple segments of fishing line together.

A convenient way for fishermen to fasten segments of fishing line together is to join the segments of fishing line in a ferrule and perform a crimping operation on the ferrule, thereby securing the segments of fishing line together. As used herein, the term ferrule means a crimping sleeve used to fasten two or more segments of fishing line together. By performing a crimping operation on a ferrule, the two segments of fishing line are compressed together. In this regard, the crimped ferrule acts as a compression joint between the two segments of fishing line. Ferrules come in many different shapes and sizes depending on the size and type of fishing line to be fastened.

The use of ferrules to fasten segments of fishing lines has its limitations. When fastening segments of fishing line in a ferrule, it is desirable to perform a crimping operation along the middle portion of the ferrule in order to avoid performing a crimping operation along the ends of the ferrule. A crimping operation performed along the ends of a ferrule may cause the end of the ferrule to present an edge against the fishing line. This edge may cut the segments of fishing line fastened by the ferrule when tension is applied to either segment of the fishing line. A cut fishing line may result in a lost catch and a lost leader line, leading to frustration.

Another disadvantage of fastening fishing lines by performing a crimping operation on ferrules is that fishing lines come in a variety of different types and sizes. Fastening fishing lines of various types and sizes therefore requires a variety of different sized ferrules. Current tools for crimping ferrules are disadvantageous for crimping multiple sized ferrules along the middle portion of a ferrule. Thus, a need exists for a fishing tool that allows a fisherman to perform a crimping operation along the middle portion of ferrules of varying sizes quickly and conveniently without crimping the ends of the ferrules.

### THE SUMMARY OF THE INVENTION

Objects and advantages of the invention will be set forth in part in the following description, or may be obvious from the description, or may be learned through practice of the invention.

In one exemplary embodiment, the present invention includes a fishing tool for crimping ferrules defining longitudinal and transverse directions. The fishing tool includes first and second handles and first and second jaws operatively connected to the first and second handles. The first and second jaws define a plurality of grooves configured for crimping ferrules. The grooves are oriented along the transverse direction and have varying transversely-oriented lengths and varying thickness. In variations of this embodiment, the first and second jaws may include indicia. The indicia signify the thickness of each groove. The first and second jaws may include a pair of notches configured for cutting. In a further variation of the present embodiment, the fishing tool may include a locking mechanism attached to one of the first and second handles or may include a pair of grips attached to the first and second handles. In still a further variation of this exemplary embodiment, the first and second jaws may be pivotally connected to each other. The first and second handles may be pivotally connected to each other. The first jaw may be pivotally connected to the first handle and the second jaw may be pivotally connected to the second handle.

In another exemplary embodiment, the present invention provides a fishing tool for crimping ferrules defining longitudinal and transverse axes. The fishing tool includes first and second handles and first and second jaws operatively connected to the first and second handles. The first and second jaws and the first and second handles are configured so that when the first and second handles come together, the first and second jaws come together. The first and second jaws define a plurality of adjacent notches configured for crimping ferrules. The notches are oriented along the transverse axis. The notches each have a transversely-oriented length and a thickness. The transversely-oriented length and thickness of each notch is different than the transversely-oriented length and thickness of each adjacent notch. The first and second jaws further define a pair of notches configured for cutting. In variations of this embodiment, the first and second jaws may include indicia. The indicia signify the thickness of each groove. In a further variation of the present embodiment, the fishing tool may include a locking mechanism attached to one of the first and second handles or may further include a pair of grips attached to the first and second handles. In still a further variation of this exemplary embodiment, the first and second jaws may be pivotally connected to each other. The first and second handles may be pivotally connected to each other. The first jaw may be pivotally connected to the first handle and the second jaw may be pivotally connected to the second handle.

In another exemplary embodiment, the present invention includes a fishing tool for crimping ferrules defining longitudinal and transverse directions. The fishing tool includes first and second handles and first and second jaws operatively connected to the first and second handles. The first and second jaws are pivotally connected to each other. The first and second handles are pivotally connected to each other. The first jaw is pivotally connected to the first handle and the second jaw is pivotally connected to the second handle. The first and second jaws define a plurality of grooves configured for crimping ferrules. The grooves are oriented along the transverse direction and have varying transversely-oriented lengths and varying thickness. In variations of this embodiment, the first and second jaws may include indicia. The indicia signify the thickness of each groove. In a further variation of this embodiment, the first and second jaws define a pair of notches. The notches are configured for cutting. In still a further variation of this embodiment, the crimping tool may include a locking mechanism attached to one of the first and second handles or may further include a pair of grips attached to the first and second handles.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present subject matter, including the best mode thereof, directed to one of ordinary skill in the art, is set forth in the specification, which makes reference to the appended figures, in which:

FIG. 1 is perspective view of an exemplary embodiment of the present invention;

FIG. 2 is close-up perspective view of an exemplary embodiment of the present invention that shows a ferrule being placed into a groove in the exemplary embodiment of the present invention;

FIG. 3 is close-up perspective view of an exemplary embodiment of the present invention performing a crimping operation on a ferrule;

FIG. 4 is cross-sectional view of an exemplary embodiment of the present invention performing a crimping operation on a ferrule taken across the line 4-4 of FIG. 3; and

FIG. 5 is an end view of an exemplary embodiment of the present invention along the longitudinal direction.

### DETAILED DESCRIPTION

Objects and advantages of the invention will be set forth in the following description, or may be apparent from the description, or may be learned through practice of the invention. Repeat use of reference characters throughout the present specification and appended drawings is intended to represent same or analogous features or elements of the invention.

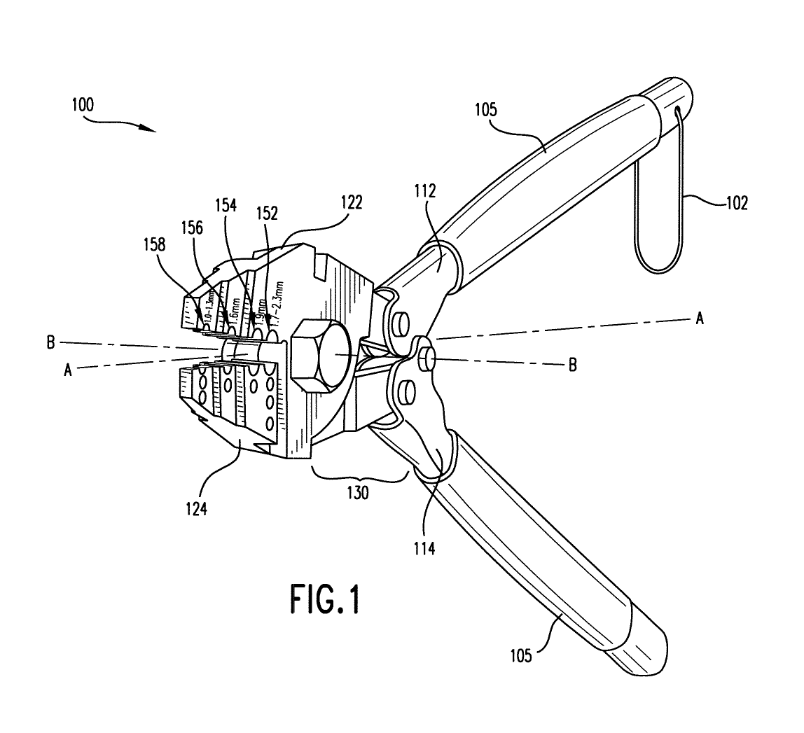

Referring now to FIG. 1, an exemplary embodiment of a fishing tool 100 according to the present invention is shown therein. The fishing tool 100 defines a longitudinal direction or axis A and a transverse direction or axis B. The fishing tool 100 includes first and second handles 112 and 114 and first and second jaws 122 and 124. The first and second handles 112 and 114 are operatively connected to the first and second jaws 122 and 124 by mechanical connection 130 so that when the first and second handles 112 and 114 come together, the first and second jaws 122 and 124 come together.

The fishing tool 100 depicted in FIG. 1 includes a locking mechanism 102 attached to the first handle 112. When in use, the locking mechanism operates to prevent the pair of first and second handles 110 from opening. The locking mechanism 102 depicted in FIG. 1 consists of a metal loop attached to the first handle 112 and operates by fitting around the second handle 114. When the locking mechanism 102 is in operation, first and second handles 112 and 114 are prevented from opening. It should be apparent using the teachings disclosed herein that other locking mechanisms known in the art may be used to prevent first and second handles 112 and 114 from opening.

The embodiment of the invention depicted in FIG. 1 includes a pair of grips 105 attached to first and second handles 112 and 114. The pair of grips 105 provides comfortable grip support for handling the fishing tool 100. The pair of grips 105 also prevents the fishing tool 100 from slipping while in operation. The pair of grips 105 may be composed of plastic, rubber, or other suitable materials known in the art.

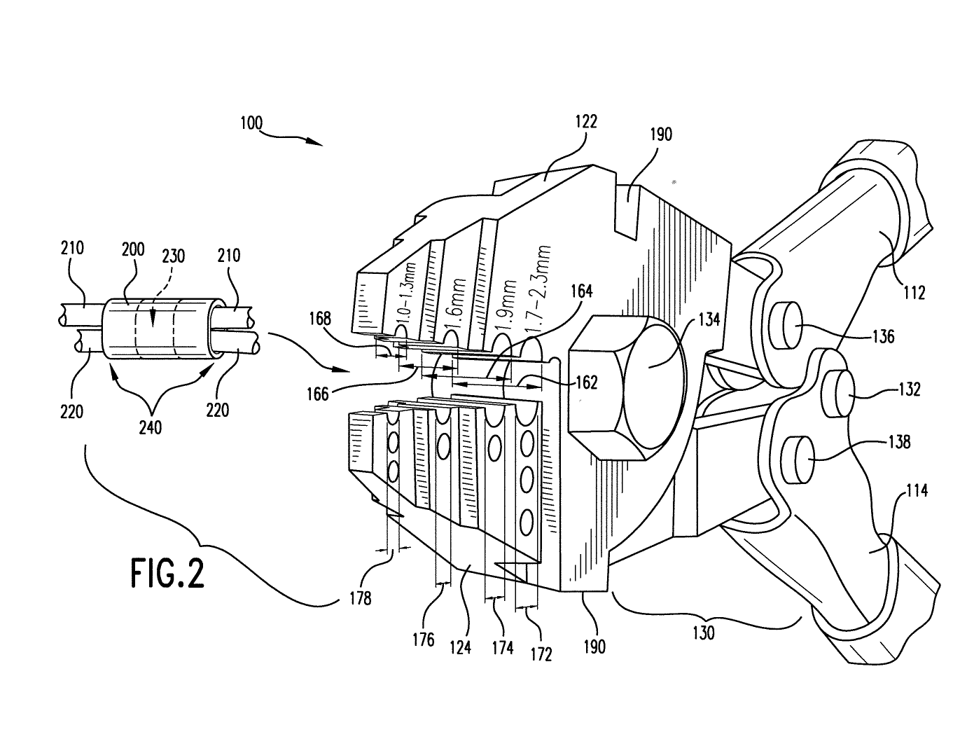

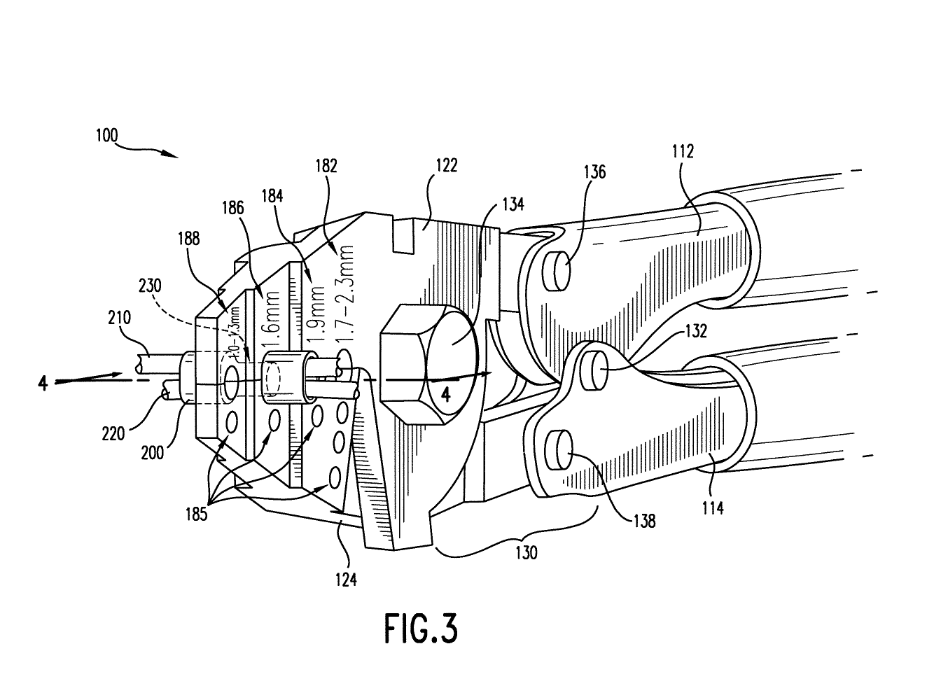

Referring now to FIGS. 2 and 3, the first and second handles 112 and 114 are operatively connected to the first and second jaws 122 and 124 by mechanical connection 130 and are configured so that when the first and second handles 112 and 114 come together, the first and second jaws 122 and 124 come together. For example, in the mechanical connection 130 of the embodiment shown in FIGS. 2 and 3, the first handle 112 is pivotally connected to the second handle 114 by pivot pin 132. The first jaw 122 is pivotally connected to the second jaw 124 by pivot pin 134. The first handle 112 is pivotally connected to the first jaw 122 by pivot pin 136, and the second handle 114 is pivotally connected to the second jaw 124 by pivot pin 138. The mechanical connection 130 described above enables greater crimping force to be applied to a ferrule than single pivot pin connections.

As shown in FIG. 1, the first and second jaws 122 and 124 define a plurality of grooves or notches 152, 154, 156, and 158 located in complementary fashion along each jaw 122 and 124. The grooves are oriented along the transverse direction or axis B. FIG. 2 provides a close-up perspective view of the grooves 152, 154, 156 and 158 of the embodiment of the fishing tool 100 depicted in FIG. 1. Referring to FIG. 2, each groove has varying transversely-oriented lengths and varying thickness. Specifically, groove 152 has transversely-oriented length 162 and thickness 172. The transversely-oriented length 162 and thickness 172 of groove 152 is different than the transversely-oriented length 164 and thickness 174 of adjacent groove 154. Similarly, the transversely-oriented length 164 and thickness 174 of groove 154 is different than the transversely-oriented length 166 and thickness 176 of adjacent groove 156. Similarly, groove 158 has a different transversely-oriented length 168 and thickness 178 than adjacent groove 156.

The varying thickness 172, 174, 176, and 178 of each groove enables the improved fishing tool 100 to conveniently crimp ferrules of varying sizes with the same fishing tool. The varying transversely-oriented lengths 162, 164, 166, and 168 of each adjacent groove further enables the improved fishing tool 100 to conveniently crimp ferrules of varying sizes along the middle portion of the ferrules in order to avoid crimping the ferrules along the ends of the ferrules. The varying transversely-oriented lengths 162, 164, 166, and 168 thus allow ferrules of multiple sizes to be crimped conveniently and effectively without crimping the ends of the ferrules. In addition, the fishing tool 100 can fasten together segments of fishing line by perform a crimping operation only once on a ferrule rather than multiple times.

The fishing tool 100 further consists of a pair of notches 190 (FIG. 2) defined by the first and second jaws 122 and 124. The notches 190 are configured for cutting. While fastening fishing lines together by performing a crimping operation on a ferrule, it is often necessary to cut fishing line and other materials. The pair of notches 190 allows for fishing tool 100 to perform these cutting operations quickly and conveniently.

Referring now to FIG. 3, the fishing tool 100 includes indicia 182, 184, 186, and 188 corresponding with each groove 152, 154, 156, and 158. The indicia 182, 184, 186, and 188 signify the thickness of each groove. For example, for this particular embodiment indicia 182 signifies the thickness of groove 152 as being from about 1.7 mm to about 2.3 mm. Indicia 184 signifies the thickness of groove 154 as being about 1.9 mm. Indicia 186 signifies the thickness of groove 156 as being about 1.6 mm. Indicia 188 signifies the thickness of groove 158 as being from about 1.0 mm to about 1.3 mm. Additional indicia 185 may also be included to color coordinate the size ferrule to be crimped in each groove 152, 154, 156, and 158. For example, each indicia may have different color for each size.

FIG. 2 displays an embodiment of a ferrule 200, as may be used with this particular embodiment. The ferrule 200 is used to connect two separate segments of fishing line 210 and 220 to each other. The two separate segments of fishing line 210 and 220 may be from separate fishing lines or may be from the same line, such as when a ferrule is used to create a loop in a fishing line. The ferrule 200 depicted in FIGS. 2-4 has a middle portion 230 and ends 240. When joining two segments of fishing line 210 and 220 with ferrule 200, it is desirable to crimp the ferrule 200 along the middle portion 230. Crimps performed on the ends 240 of the ferrule 200 may cause the ends 240 to present an edge against the fishing line. The edge may cut the fishing line fastened together by ferrule 200 when tension is applied to either segment 210 or 220 of the fishing line.

The present invention avoids performing an undesirable crimping operation on the ends 240 of ferrule 200. Each groove 152, 154, 156, and 158 of the fishing tool 100 has a transversely-oriented length 162, 164, 166, and 168 that is configured so that middle portion 230 of ferrule 200 is crimped when fishing tool 100 performs a crimping operation on ferrule 200. By having a plurality of grooves 152, 154, 156, and 158 with varying transversely-oriented lengths 162, 164, 166, and 168, the present invention allows for the effective crimping of ferrules of multiple sizes along the middle portion 230 of such ferrules quickly and conveniently without crimping the ends 240 of the ferrules. The plurality of grooves 152, 154, 156, and 158 also enable the present invention to fasten together segments of fishing line by perform a crimping operation only once on a ferrule rather than multiple times.

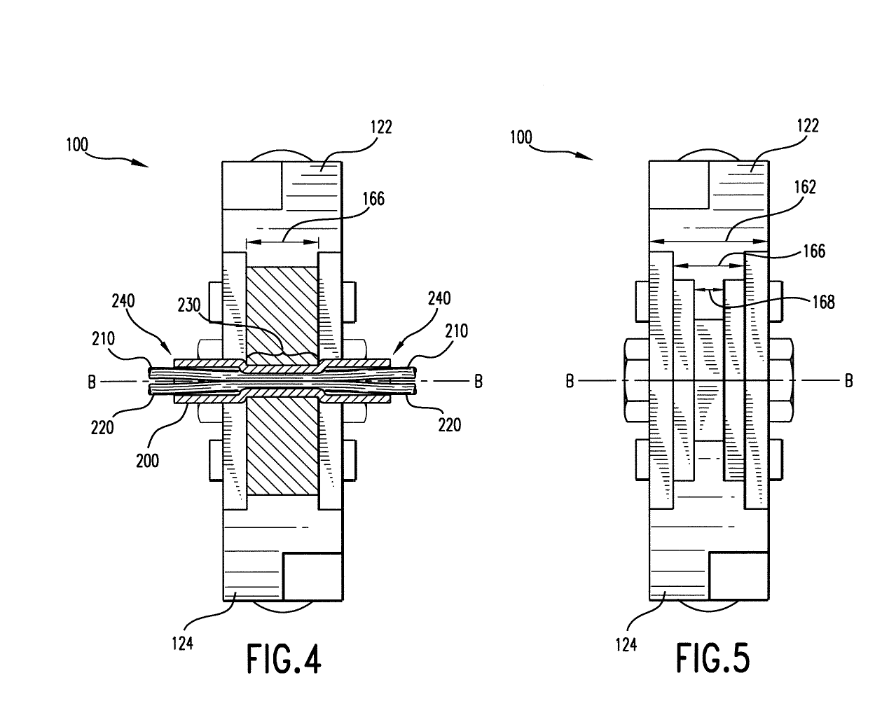

FIGS. 3 and 4 display how an embodiment of the present invention can be used to perform a crimping operation along the middle portion 230 of ferrule 200. The ferrule 200 with size corresponding to the thickness 176 of groove 156 is placed in groove 156. The transversely-oriented length 166 of groove 156 is configured so as to enclose the middle portion 230 of ferrule 200. The fishing tool 100 performs a crimping operation on ferrule 200 when the first and second handles 112 and 114 are brought together causing the first and second jaws 122 and 124 to come together. The mechanical connection 130 depicted in FIGS. 1-3 is such that less force is required to perform a crimping operation on the ferrule 200 as may be required with other single pivot pin connections. When the first and second jaws 122 and 124 come together, the ferrule 200 is crimped along the middle portion 230. The ferrule 200 is not crimped along the ends 240. Thus, the two segments of fishing line 210 and 220 are secured without the danger of being cut by an edge of ferrule 200.

FIG. 4 displays a cross-sectional view of the crimping operation described above taken across line 4-4 of FIG. 3. FIG. 4 further illustrates how an exemplary embodiment of the present invention performs a crimping operation along the middle portion 230 of ferrule 200. As is apparent from FIG. 4, the transversely-oriented length 166 of groove 156 is configured so as to enclose the middle portion 230 of ferrule 200. The ends 240 of ferrule 200 are not enclosed in groove 156 of the fishing tool 100. Thus, the ends 240 are not compressed when fishing tool 100 performs a crimping operation along middle portion 230 of ferrule 200. The two segments of fishing line 210 and 220 are secured in the middle portion 230 of ferrule 200 without the danger of being cut by an edge of ferrule 200. The two segments of fishing line 210 and 220 are securely fastened together by performing a crimping operation only once on ferrule 200.

FIG. 5 displays an end view of an exemplary embodiment of the present invention from the longitudinal direction. FIG. 5 shows the varying transversely-oriented lengths 162, 166, and 168 of the grooves 152, 156, and 158. FIG. 5 does not illustrate the transversely-oriented length 164 of groove 154. These varying transversely-oriented lengths 162, 164, 166, and 168 enable the fishing tool 100 to perform crimping operations along the middle portion of ferrules of varying sizes. In this regard, the fishing tool 100 provides a convenient, effective tool for fastening multiple segments of fishing lines of varying sizes by performing a crimping operation on ferrules without crimping the ends of the ferrules. In addition, the fishing tool 100 securely fastens segments of fishing line together by performing a crimping operation only once on a ferrule rather than multiple times.

While the present subject matter has been described in detail with respect to specific embodiments thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

1. A fishing tool for crimping ferrules, the tool defining longitudinal and transverse directions, the tool comprising:
first and second handles,
first and second jaws operatively connected to said first and second handles,
wherein said first and second jaws define a plurality of grooves configured for crimping ferrules, said grooves are oriented along the transverse direction, and
said grooves have varying transversely-oriented lengths and varying thickness.

2. The fishing tool of claim 1, wherein said first and second jaws further comprise indicia corresponding with said grooves, said indicia signifying the thickness of each said groove.

3. The fishing tool of claim 1, wherein said first and second jaws define a pair of notches, said notches configured for cutting.

4. The fishing tool of claim 1, further comprising a locking mechanism attached to one of said first and second handles.

5. The fishing tool of claim 1, further comprising a pair of grips attached to said first and second handles.

6. The fishing tool of claim 1, wherein said first and second jaws are pivotally connected to each other, said first and second handles are pivotally connected to each other, said first jaw is pivotally connected to said first handle, and said second jaw is pivotally to said second handle.

7. A fishing tool for crimping ferrules, the tool defining longitudinal and transverse axes, the tool comprising
first and second handles,
first and second jaws operatively connected to said first and second handles and configured so that when said first and second handles come together, said first and second jaws come together,
said first and second jaws defining a plurality of adjacent notches configured for crimping ferrules,
said notches oriented along the transverse axis, each said notch having a transversely-oriented length and a thickness,
wherein said transversely-oriented length and thickness of each said notch is different than said transversely-oriented length and thickness of each said adjacent notch, and
said first and second jaws further defining a pair of notches configured for cutting.

8. The fishing tool of claim 7, wherein said first and second jaws further comprise indicia corresponding with said notches, said indicia signifying the thickness of each said notch.

9. The fishing tool of claim 7, further comprising a locking mechanism attached to one of said first and second handles.

10. The fishing tool of claim 7, further comprising a pair of grips attached to said first and second handles.

11. The fishing tool of claim 7, wherein said first and second jaws are pivotally connected to each other, said first and second handles are pivotally connected to each other, said first jaw is pivotally connected to said first handle, and said second jaw is pivotally to said second handle.

12. A fishing tool for crimping ferrules, the tool defining longitudinal and transverse directions, the tool comprising
first and second handles,
first and second jaws operatively connected to said first and second handles,
wherein said first and second jaws are pivotally connected to each other, said first and second handles are pivotally connected to each other, said first jaw is pivotally connected to said first handle, and said second jaw is pivotally connected to said second handle, and
wherein said first and second jaws define a plurality of grooves configured for crimping ferrules, said grooves are oriented along the transverse direction, and
said grooves have varying transversely-oriented lengths and varying thickness.

13. The fishing tool of claim 12, wherein said first and second jaws further comprise indicia corresponding with said grooves, said indicia signifying the thickness of each said groove.

14. The fishing tool of claim 12, wherein said first and second jaws define a pair of notches, said notches configured for cutting.

15. The fishing tool of claim 12, further comprising a locking mechanism attached to one of said first and second handles.

16. The fishing tool of claim 12, further comprising a pair of grips attached to said first and second handles.

17. The fishing tool of claim 1, wherein the grooves are configured to crimp a ferrule only along the middle portion of the ferrule.

18. The fishing tool of claim 7, wherein the notches are configured to crimp a ferrule only along the middle portion of the ferrule.

19. The fishing tool of claim 12, wherein the grooves are configured to crimp a ferrule only along the middle portion of the ferrule.
